(19) United States
(12) Patent Application Publication
(10) Pub. No.: US 2024/0098763 A1
(43) Pub. Date: Mar. 21, 2024

(54) SIDELINK RESOURCE POOL CONFIGURATION

(71) Applicant: QUALCOMM Incorporated, San Diego, CA (US)

(72) Inventors: Kianoush HOSSEINI, San Diego, CA (US); Wei YANG, San Diego, CA (US); Alexandros MANOLAKOS, Escondido, CA (US)

(21) Appl. No.: 18/263,685

(22) PCT Filed: Apr. 14, 2022
(86) PCT No.: PCT/US2022/071716

§ 371 Date: Jul. 31, 2023

(30) Foreign Application Priority Data
Apr. 15, 2021 (GR) 20210100269

(51) Int. Cl. H04W 72/40; H04W 72/0453

(52) U.S. Cl. CPC H04W 72/40; H04W 72/0453

(57) ABSTRACT

Various aspects of the present disclosure generally relate to wireless communication. In some aspects, a user equipment (UE) may receive information indicating a plurality of resources for a resource pool associated with sidelink communication. The UE may identify a set of resources of the plurality of resources to be included in the resource pool, wherein identifying the set of resources is based at least in part on one or more resources of the plurality of resources being sub-band full duplex resources. The UE may communicate on the resource pool using at least part of the set of resources. Numerous other aspects are described.

### CROSS-REFERENCE TO RELATED APPLICATION

This Patent application claims priority to Greece Patent Application No. 20210100269, filed on Apr. 15, 2021, entitled “SIDELINK RESOURCE POOL CONFIGURATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for sidelink resource pool configuration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving information indicating a plurality of resources for a resource pool associated with sidelink communication; identifying a set of resources of the plurality of resources to be included in the resource pool, wherein identifying the set of resources is based at least in part on one or more resources of the plurality of resources being sub-band full duplex (SBFD) resources; and communicating on the resource pool using at least part of the set of resources.

In some aspects, a method of wireless communication performed by a network entity includes identifying a plurality of resources for a resource pool associated with sidelink communication, wherein a set of resources of the plurality of resources are included in the resource pool, wherein the set of resources is based at least in part on one or more resources of the plurality of resources being smaller-bandwidth resources that are associated with a smaller bandwidth than a remainder of the plurality of resources; and transmitting information indicating the plurality of resources for the resource pool or the set of resources for the resource pool.

In some aspects, a UE for wireless communication includes a memory and one or more processors, coupled to the memory, configured to: receive information indicating a plurality of resources for a resource pool associated with sidelink communication; identify a set of resources of the plurality of resources to be included in the resource pool, wherein identifying the set of resources is based at least in part on one or more resources of the plurality of resources being smaller-bandwidth resources that are associated with a smaller bandwidth than a remainder of the plurality of resources; and communicate on the resource pool using at least part of the set of resources.

In some aspects, a network entity for wireless communication includes a memory and one or more processors, coupled to the memory, configured to: identify a plurality of resources for a resource pool associated with sidelink communication, wherein a set of resources of the plurality of resources are included in the resource pool, wherein the set of resources is based at least in part on one or more resources of the plurality of resources being smaller-bandwidth resources that are associated with a smaller bandwidth than a remainder of the plurality of resources; and transmit information indicating the plurality of resources for the resource pool or the set of resources for the resource pool.

In some aspects, a non-transitory computer-readable medium storing a set of instructions for wireless communication includes one or more instructions that, when executed by one or more processors of a UE, cause the UE to: receive information indicating a plurality of resources for a resource pool associated with sidelink communication; identify a set of resources of the plurality of resources to be included in the resource pool, wherein identifying the set of resources is based at least in part on one or more resources of the plurality of resources being smaller-bandwidth resources that are associated with a smaller bandwidth than a remainder of the plurality of resources; and communicate on the resource pool using at least part of the set of resources.

In some aspects, a non-transitory computer-readable medium storing a set of instructions for wireless communication includes one or more instructions that, when executed by one or more processors of a network entity, cause the network entity to: identify a plurality of resources for a resource pool associated with sidelink communication, wherein a set of resources of the plurality of resources are included in the resource pool, wherein the set of resources is based at least in part on one or more resources of the plurality of resources being smaller-bandwidth resources that are associated with a smaller bandwidth than a remainder of the plurality of resources; and transmit information indicating the plurality of resources for the resource pool or the set of resources for the resource pool.

In some aspects, an apparatus for wireless communication includes means for receiving information indicating a plurality of resources for a resource pool associated with sidelink communication; means for identifying a set of resources of the plurality of resources to be included in the resource pool, wherein identifying the set of resources is based at least in part on one or more resources of the plurality of resources being smaller-bandwidth resources that are associated with a smaller bandwidth than a remainder of the plurality of resources; and means for communicating on the resource pool using at least part of the set of resources.

In some aspects, an apparatus for wireless communication includes means for identifying a plurality of resources for a resource pool associated with sidelink communication, wherein a set of resources of the plurality of resources are included in the resource pool, wherein the set of resources is based at least in part on one or more resources of the plurality of resources being smaller-bandwidth resources that are associated with a smaller bandwidth than a remainder of the plurality of resources; and means for transmitting information indicating the plurality of resources for the resource pool or the set of resources for the resource pool.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of a sub-band full duplex (SBFD) slot, in accordance with the present disclosure.

FIG. 6 is a diagram illustrating an example of one or more resource pools, in accordance with the present disclosure.

FIG. 7 is a diagram illustrating an example of determination of a resource pool based at least in part on an SBFD operation, in accordance with the present disclosure.

FIGS. 8-9 are diagrams illustrating example processes associated with determination of a resource pool based at least in part on an SBFD operation, in accordance with the present disclosure.

FIGS. 10-11 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

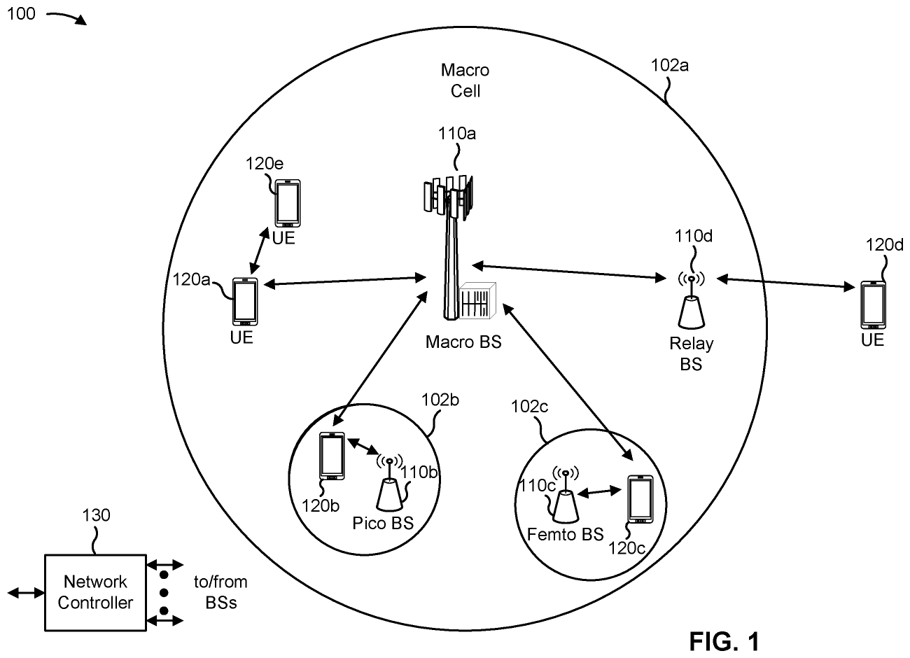

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. A wireless node may provide, for example, connectivity for or to a network (e.g., a wide area network such as Internet or a cellular network) via a wired or wireless communication link. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

Deployment of communication systems, such as 5G New Radio (NR) systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), transmit receive point (TRP), or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

As indicated above, FIG. 1 is provided as an example. Other examples may differ from what is described with regard to FIG. 1.

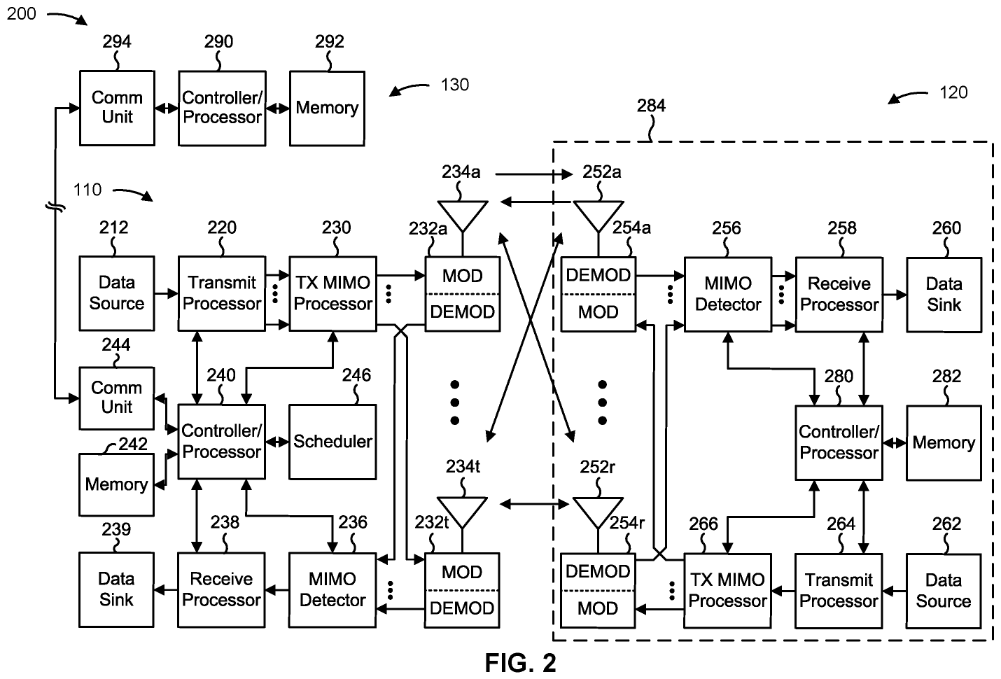

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

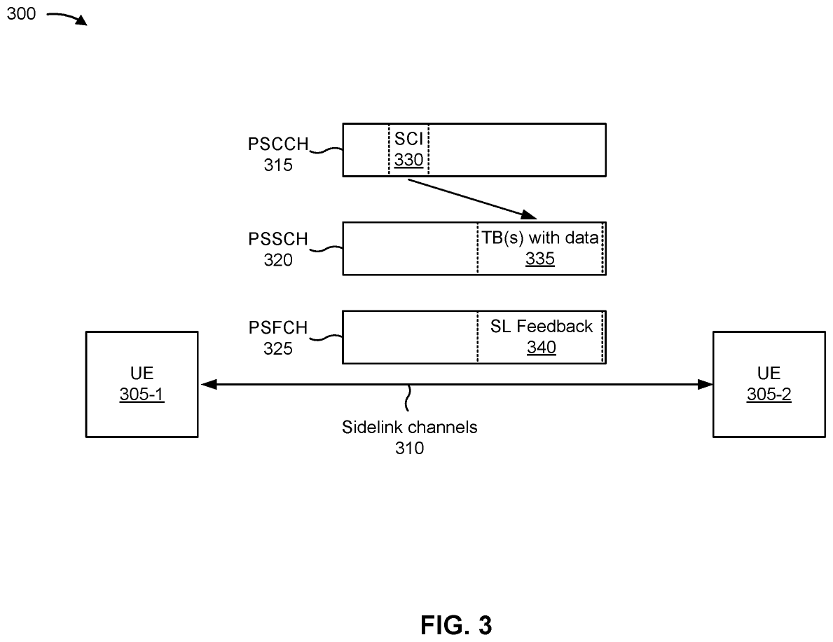

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (for example, as described with reference to FIGS. 3-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (for example, as described with reference to FIGS. 3-9).

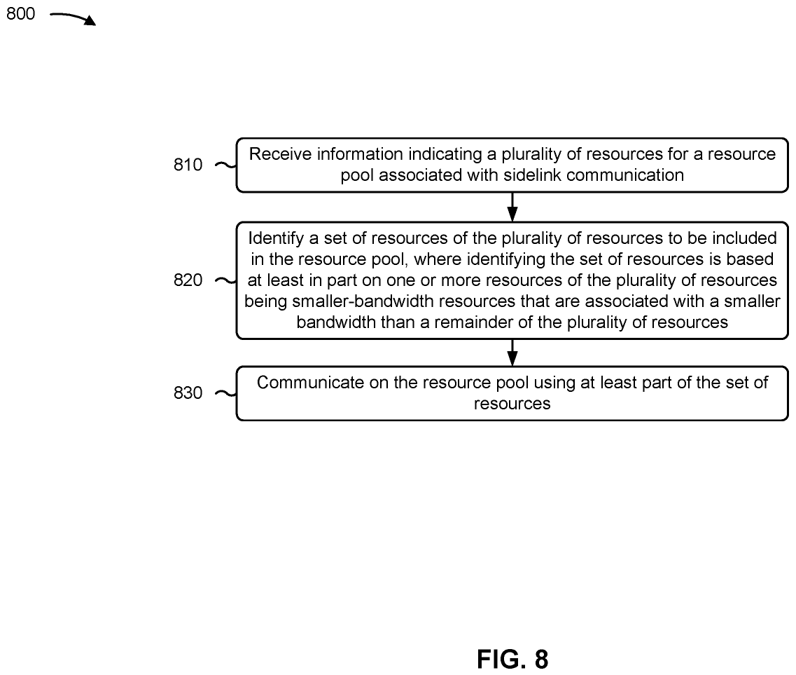

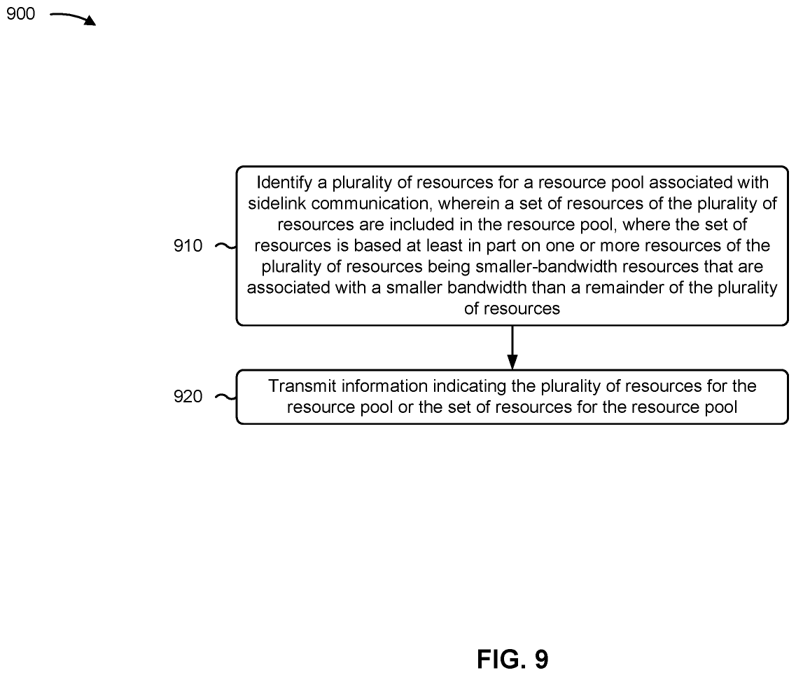

The controller/processor 240 of the base station 110, the controller/processor 280 of the UE 120, and/or any other component(s) of FIG. 2 may perform one or more techniques associated with sidelink resource pool configuration, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving information indicating a plurality of resources for a resource pool associated with sidelink communication; means for identifying a set of resources of the plurality of resources to be included in the resource pool, wherein identifying the set of resources is based at least in part on one or more resources of the plurality of resources being smaller-bandwidth resources that are associated with a smaller bandwidth than a remainder of the plurality of resources; and/or means for communicating on the resource pool using at least part of the set of resources. The means for the UE to perform operations described herein may include, for example, one or more of antenna 252, modem 254, MIMO detector 256, receive processor 258, transmit processor 264, TX MIMO processor 266, controller/processor 280, or memory 282.

In some aspects, the UE includes means for receiving information indicating another plurality of resources for a second resource pool associated with sidelink communication, wherein the other plurality of resources includes only uplink resources.

In some aspects, the UE includes means for identifying a truncated set of resource blocks, from the set of resource blocks, for a smaller-bandwidth resource.

In some aspects, the network entity includes means for identifying a plurality of resources for a resource pool associated with sidelink communication, wherein a set of resources of the plurality of resources are included in the resource pool, wherein the set of resources is based at least in part on one or more resources of the plurality of resources being smaller-bandwidth resources that are associated with a smaller bandwidth than a remainder of the plurality of resources; and/or means for transmitting information indicating the plurality of resources for the resource pool or the set of resources for the resource pool. In some aspects, the means for the network entity to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246. For example, the network entity may be a base station, a gNB that communicates with a UE via a base station, a gNB that communicates with a UE via a relay, or the like.

In some aspects, the network entity includes means for transmitting information indicating another plurality of resources for a second resource pool associated with sidelink communication, wherein the other plurality of resources includes only uplink resources.

In some aspects, the network entity includes means for identifying a truncated set of resource blocks, from the set of resource blocks, for an SBFD resource.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, vehicle-to-person (V2P) communications, and/or the like), mesh networking, and/or the like. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, symbols, and/or the like) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, spatial resources, and/or the like) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), a scheduling request (SR), and/or the like.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a transmission mode where resource selection and/or scheduling is performed by the UE 305 (e.g., rather than a base station 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, may measure a reference signal received quality (RSRQ) parameter (e.g., a PSSCH-RSRQ parameter) associated with various sidelink channels, and/or the like, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources, channel parameters, and/or the like. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, a modulation and coding scheme (MCS) to be used for the upcoming sidelink transmission, and/or the like. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

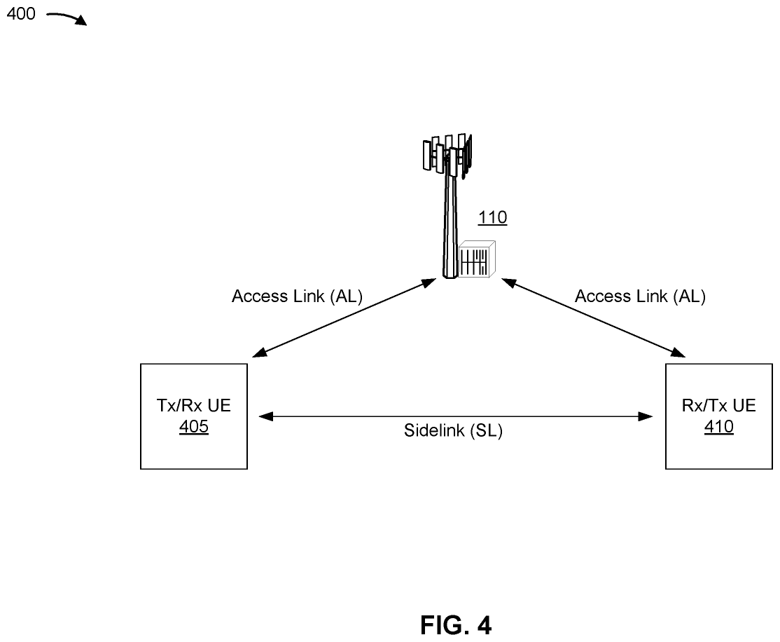

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

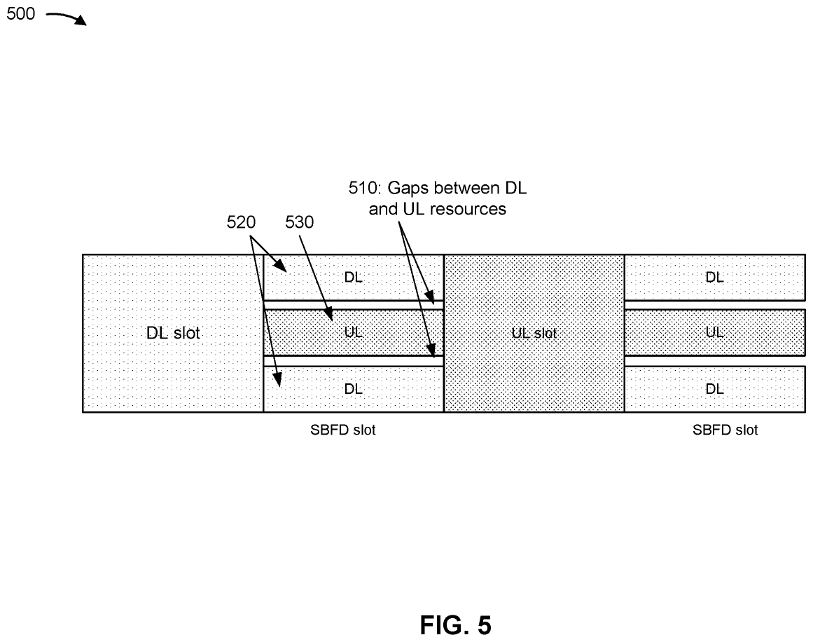

FIG. 5 is a diagram illustrating an example 500 of a sub-band full duplex (SBFD) slot, in accordance with the present disclosure. Example 500 shows a downlink (DL) slot, an uplink (UL) slot, and two SBFD slots. A DL slot is a slot that can be used for downlink communication from a base station to a UE (such as via a Uu radio access connection). A UL slot is a slot that can be used for uplink communication from a UE to a base station (such as via a Uu radio access connection) or, in some cases, for sidelink communication between UEs. For example, UEs may communicate on the sidelink (such as using a ProSe Sidelink (PC5) interface) via uplink resources that are configured as sidelink resources, as described elsewhere herein. In some aspects, a UL slot may be configured such that all symbols are uplink symbols (excluding symbols used for gaps, reference signaling, measurement, and so on). In some aspects, a UL slot may be a slot that contains a threshold number of uplink symbols. For example, symbols of a given slot can be configured as downlink symbols, uplink symbols, or another type of symbol. If a threshold number of symbols are configured as uplink symbols, then the given slot may be considered a UL slot. In some aspects, a DL slot may be configured such that all symbols are downlink symbols (excluding symbols used for gaps, reference signaling, measurement, and so on). In some aspects, a DL slot may be a slot that contains a threshold number of downlink symbols. For example, if a threshold number of symbols are configured as downlink symbols, then the given slot may be considered a DL slot.

An SBFD slot is a slot that is configured for SBFD communication. Full-duplex (FD) communication has been introduced as a means to provide increased bandwidth (ideally, double the bandwidth of half-duplex) by allowing a gNB or UE to transmit and receive on the same set of resources, such as the same set of time and frequency (time/frequency) resources. However, due to complications with transmitting and receiving on the same set of resources (e.g., self-interference between downlink and uplink transmission, gNB-to-gNB interference, and UE-to-UE interference) and additional implementation complexity, SBFD is considered as a step to realize some of the benefits of FD communications, while circumventing some of the complications of FD communications. For example, in an SBFD slot, gaps 510 may be configured between downlink resources 520 and UL resources 530, which enables better control of self-interference while improving latency and uplink coverage. The total bandwidth of example 500 may be a bandwidth part (BWP), a component carrier (CC), or the like. SBFD can be implemented at the UE and/or at the base station. For example, a base station may use SBFD to perform FD communication with multiple UEs (such as uplink communication with one UE and downlink communication with another UE in the same slot)

A UE may receive information indicating which slots are SBFD slots. For example, information indicating SBFD slots may be signaled via a common radio resource control (RRC) configuration (such as via a system information block). As another example, information indicating SBFD slots may be signaled via UE-specific signaling, such as UE-specific RRC signaling or another form of signaling. As yet another example, information indicating SBFD slots may be indicated to a UE dynamically (such as by using downlink control information (DCI) or medium access control (MAC) signaling). In some aspects, UL slots and/or symbols and DL slots and/or symbols may be semi-statically configured, such as via RRC signaling.

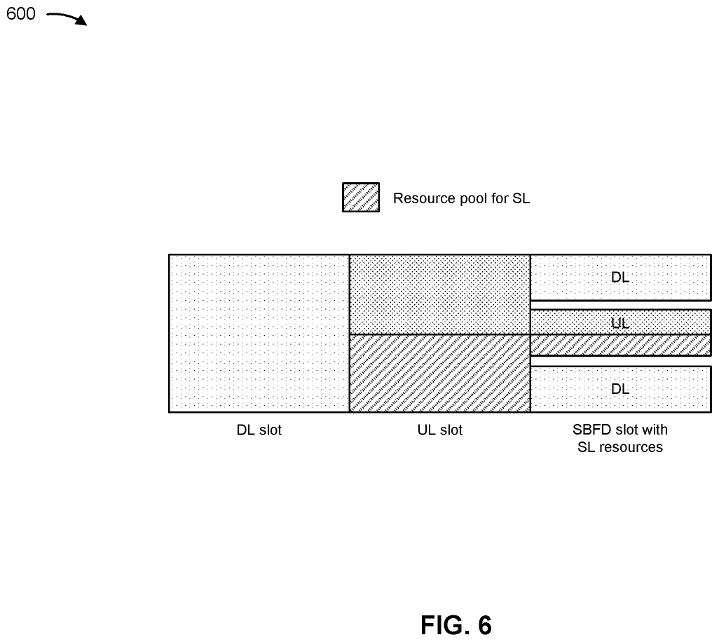

FIG. 6 is a diagram illustrating an example 600 of one or more resource pools, in accordance with the present disclosure. Example 600 shows a DL slot, a UL slot, and an SBFD slot including sidelink (sometimes abbreviated SL) resources. These slot types are described in more detail in connection with FIG. 5.

As mentioned above, sidelink communications may occur via a resource pool, and may be allowed (e.g., only) on symbols that are semi-statically configured as uplink symbols. A resource pool is a set of time/frequency resources in which a UE is permitted to transmit sidelink communications. It can be seen that a resource pool includes symbols that are semi-statically configured as uplink symbols because a UE may be expected to transmit sidelink communications on such symbols. One or more resource pools in example 600 are indicated by a diagonal fill.

A UE can be configured (e.g., via configuration signaling such as RRC signaling, via pre-configuration such as by an original equipment manufacturer or service provider, or the like) with a set of resource pools, wherein each resource pool is defined as time/frequency resources. The minimum transmission/reception (e.g., resource allocation) unit in time is a sub-channel, wherein each sub-channel is defined as a number of contiguous resource blocks (RBs).

A resource pool can further be configured with one of the two resource allocation modes described in connection with FIGS. 3 and 4. For example, a resource pool can be configured with Mode 1 resource allocation, in which a network entity such as a gNB assigns resources for sidelink transmission. In Mode 1, both dynamic allocation via a DCI format 3-x and configured transmissions (of Type-1, wherein an uplink grant and activation/deactivation signaling for the uplink grant are both provided via RRC signaling, and of Type-2, wherein an uplink grant configuration is provided via RRC signaling and activation/deactivation signaling for the uplink grant are provided via a control channel grant (e.g., via DCI)) are supported. As another example, a resource pool can be configured with Mode 2 resource allocation, in which a UE senses the resources of the resource pool. Based at least in part on the outcome of the sensing (e.g., based at least in part on priority of different transmissions and a reference signal received power (RSRP) determined by the sensing), a UE may autonomously select resources for a transmission. In some deployments, Mode 1 operation may generally be expected for UEs in coverage of a network entity such as a gNB, whereas Mode 2 operation may generally be expected for UEs out of coverage of the network entity.

A UE may receive information indicating a plurality of time/frequency resources for a resource pool, and may identify a set of sidelink slots to be included in the resource pool. For example, the set of sidelink slots may be identified (e.g., selected) from the resources. In some cases, the set of slots that may belong to a sidelink resource pool is denoted by (t₀^{SL}, t₁^{SL}, . . . , t_{T}_{ₘₐₓ}₋₁^{SL}), wherein 0≤tᵢ^{SL}<10240×2^{μ}, 0≤i<Tₘₐₓ, wherein the slot index is relative to slot #0 of the radio frame corresponding to system frame number (SFN) 0 of the serving cell or direct frame number (DFN) 0, and where μ is a subcarrier spacing of the BWP or CC in question. The set of sidelink slots may include all slots except:
N_{S_SSB} slots in which a sidelink synchronization signal/physical sidelink broadcast channel (S-SS/PSBCH) block (S-SSB) is configured;
N_{nonSL} slots in each of which at least one of Y-th, (Y+1)-th, (Y+X−1)-th OFDM symbols are not semi-statically configured as uplink as per the higher layer parameter tdd-UL-DL-ConfigurationCommon or sl-TDD-Configuration, wherein Y and X are set by the higher layer parameters sl-StartSymbol and sl-LengthSymbols, respectively; and
one or more reserved slots, which are determined by the following steps:
   a. the remaining slots excluding N_{S_SSB} slots and N_{nonSL} slots from the set of all the slots are denoted by (l₀, l₁, . . . , l_{(10240×2}_{^{μ}}_{-N}_{_{SSSB}}_{-N}_{_{nonSL}}₋₁₎) arranged in increasing order of slot index;
   b. a slot lᵣ(0≤r<10240×2^{μ}−N_{S}_{_{SSB}}−N_{nonSL}) belongs to the reserved slots if

$$r = ⌊ \frac{m \cdot ( 10240 \times {2}^{μ} - {N}_{{S}_{SSB}} - {N}_{nonSL} )}{{N}_{reserved}} ⌋ .$$

Here, m=0, 1, . . . , N_{reserved}−1 and N_{reserved}=(10240×2^{μ}−N_{S}_{_{SSB}}−N_{nonSL}) mod L_{bitmap}, wherein L_{bitmap} denotes the length of the bitmap and is configured by higher layers (such as with the configuration information for the resource pool or separately from the configuration information for the resource pool).
   The set of sidelink slots may be arranged in increasing order of slot index.

Configuration information for a resource pool (e.g., information identifying a plurality of resources for the resource pool) may indicate a plurality of slots, and a UE may select, from the plurality of slots, a set of slots, as described above. The configuration information may indicate the plurality of slots using a bitmap (b₀, b₁, . . . , b_{L}_{_{bitmap}}₋₁) associated with the resource pool, wherein L_{bitmap} (e.g., the length of the bitmap) is configured by higher layers, as mentioned above. A slot tₖ^{SL} (0≤k<10240×2^{μ}−N_{S}_{_{SSB}}−N_{nonSL}−N_{reserved}) belongs to the set if b_{k′}=1, wherein k′=k mod L_{bitmap}. The slots in the set may be re-indexed such that the subscripts i of the remaining slots t′ᵢ^{SL} are successive {0, 1, . . . , T′^{max}−1}, wherein T′max is the number of the slots remaining in the set.

Example 600 is an example where Uu operations (e.g., between a UE and a base station) and sidelink operations (e.g., between UEs) are performed in the same bandwidth, such as on the same carrier. This may occur, for example, when a sidelink network is deployed in licensed spectrum. Further, example 600 is an example where at least a gNB (and potentially one or more UEs) supports SBFD operation. Therefore, at least some of the slots of example 600 (e.g., the right-most slot) are configured (dynamically or semi-statically) as SBFD slots. Thus, the bandwidth of the uplink portion of the SBFD slot is smaller than that of the uplink slot of example 600. It can be seen that the smaller bandwidth of the uplink portion of the SBFD slot reduces the bandwidth of the resource pool in the SBFD slot relative to the uplink slot, since the UE cannot use downlink or gap resources for the resource pool.

Certain difficulties or ambiguities may arise when a slot that is assigned for SBFD operation (e.g., configured as an SBFD slot) is included in a sidelink resource pool configuration. For example, as mentioned above, the SBFD slot may be associated with a smaller uplink bandwidth than an uplink slot, which may constrain the available bandwidth for sidelink operation, thereby reducing throughput of the UE. As another example, ambiguity may arise as to whether an uplink portion of a SBFD slot should be included in a resource pool, as well as how a bandwidth of the resource pool is affected after the SBFD slot (e.g., should the bandwidth return to a bandwidth prior to the SBFD slot, or should the bandwidth remain as the uplink bandwidth of the SBFD slot). As yet another example, ambiguity may arise in how a sub-channel size should be determined for a resource pool (since a sub-channel size is based at least in part on a bandwidth of an uplink portion of a slot). These ambiguities and difficulties may lead to diminished sidelink throughput, misconfiguration of UE communications, and suboptimal utilization of network resources. Furthermore, while the description focuses on SBFD slots, these difficulties and ambiguities can arise for any sort of narrower-bandwidth slot.

Techniques and apparatuses described herein provide rules for interaction between SBFD configuration (such as configuration of a set of narrower-bandwidth slots) and resource pool configuration. For example, some techniques described herein indicate whether a slot that is configured as an SBFD slot (e.g., a narrower-bandwidth slot) can be assigned for sidelink operation (e.g., can be included in a resource pool). Some techniques and apparatuses described herein indicate how a number of sub-channels (e.g., a sub-channel size) for a resource pool should be determined if the resource pool includes a narrower-bandwidth slot such as an SBFD slot. Furthermore, some techniques and apparatuses described herein indicate how a bandwidth of a resource pool should be determined (e.g., by truncation of the resource pool in a narrower-bandwidth slot such as an SBFD slot to be within an uplink portion of the narrower-bandwidth slot such as the SBFD slot, or by configuration by a base station such that the resource pool includes only one of uplink slots or narrower-bandwidth slots). In this way, sidelink throughput is improved, misconfiguration of UE communications is reduced, and utilization of network resources is improved.

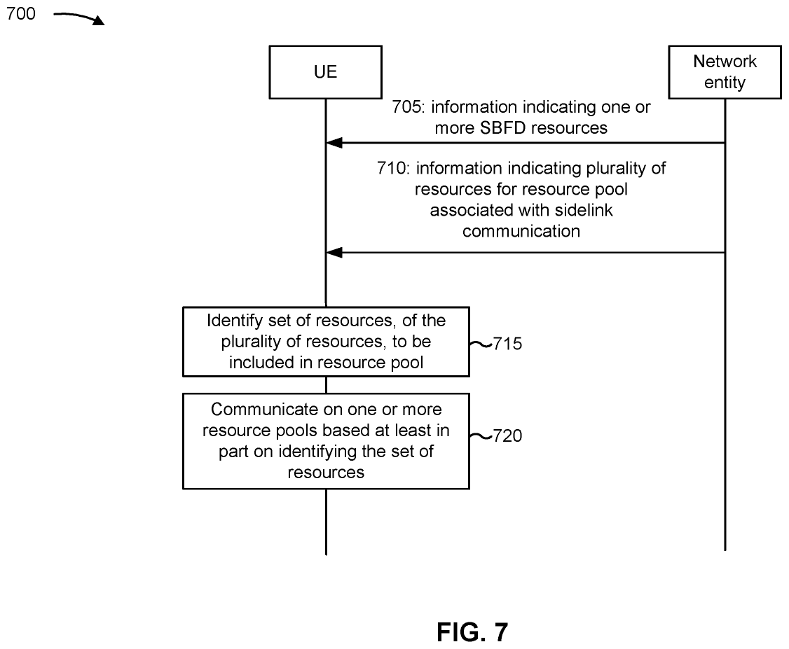

FIG. 7 is a diagram illustrating an example 700 of determination of a resource pool based at least in part on an SBFD operation, in accordance with the present disclosure. As shown, example 700 includes a UE (e.g., UE 120, UE 305, UE 405, UE 410) and a network entity (e.g., BS 110, a gNB). In example 700, “uplink slot” refers to a slot semi-statically configured as an uplink slot, or a slot semi-statically configured with at least a threshold number of uplink symbols. Generally, and depending on context, “resource” is used interchangeably with “slot” in example 700.

As shown in FIG. 7, and by reference number 705, the network entity may provide, to the UE, information indicating one or more SBFD resources. For example, the network entity may provide information indicating one or more SBFD slots. In some aspects, the information indicating one or more SBFD slots may be provided via radio resource control (RRC) signaling, medium access control (MAC) signaling, downlink control information (DCI), or the like. In some aspects, the information indicating one or more SBFD slots may be provided semi-statically. The information indicating the one or more SBFD slots may identify the one or more SBFD slots, and may indicate one or more downlink portions, one or more uplink portions, and/or one or more gap portions of an SBFD slot. In some aspects, the information indicating the one or more SBFD slots may additionally indicate which slots are uplink slots, which slots are downlink slots, or the like. In some aspects, the one or more SBFD slots may be one or more semi-static SBFD slots, such as SBFD slots that are indicated via semi-static signaling.

While example 700 is described with reference to SBFD slots, the operations of example 700 can be performed for any sort of smaller-bandwidth slot. A smaller-bandwidth slot is a slot associated with a narrower bandwidth than a baseline slot (e.g., a slot utilizing a full bandwidth of a carrier or a bandwidth part) or than another slot in a group slots. References to “SBFD slots” herein should be understood to refer to “smaller-bandwidth slots,” of which SBFD slots are an example.

As shown by reference number 710, the network entity may provide, to the UE, information indicating a plurality of resources (e.g., time/frequency resources) for a resource pool associated with sidelink communication (e.g., a sidelink resource pool). For example, the network entity may provide a resource pool configuration to the UE. The resource pool configuration may include at least part of the information described above in connection with FIG. 6. In some aspects, the information shown by reference number 710 may relate to a single resource pool. In some aspects, the information shown by reference number 710 may relate to multiple resource pools. As shown, the information may indicate a plurality of resources for the resource pool. For example, the network entity may identify the plurality of resources.

In some aspects, the UE may be pre-configured with at least part of the information shown by reference number 705 and reference number 710.

As shown by reference number 715, the UE may identify a set of resources, of the plurality of resources, to be included in the resource pool. For example, as described in connection with FIG. 6, some resources may not be permitted in a resource pool. The UE may identify such resources, and may exclude such resources from the set of resources to be included in the resource pool. One procedure for identifying resources to be excluded from a resource pool is described in connection with FIG. 6. For example, the UE may identify resources associated with transmission of a synchronization signal/PBCH block (SSB), downlink slots, and/or slots that are associated with less than a threshold number of semi-static uplink symbols, and may exclude such resources and slots from the resource pool.

In some aspects, one or more SBFD slots may be excluded from the resource pool. For example, a rule may specify that one or more resources that are SBFD resources cannot be included in the set of resources that make up the resource pool (e.g., that slots that are semi-statically indicated to be for SBFD operation cannot be assigned to sidelink operation). In this case, in addition to removing slots with less than the threshold number of semi-static uplink symbols, the UE may remove the slots that are semi-statically indicated to be for SBFD operation. For example, a step may be specified, in a wireless communication specification regarding which slots to remove from resource pools, indicating to remove slots that are semi-statically indicated to be for SBFD operation.

In some aspects, slots that are semi-statically indicated to be for SBFD operation can be used for sidelink operation. For example, one or more resources that are SBFD resources may be included in the set of resources that make up the resource pool. In some aspects, the UE may determine whether an SBFD slot is to be included in the set of resources based at least in part on whether a bandwidth of an uplink portion of the one or more resources satisfies a threshold. For example, sidelink operation may not be allowed in SBFD slots in which the bandwidth of the uplink portion is set to be smaller than a threshold. As an example, the threshold could be set at a smallest bandwidth allowed for sidelink operation (e.g., 5 MHz, 10 MHz, or the like). The UE may selectively exclude a resource (e.g., an SBFD slot) based at least in part on whether the resource is associated with a bandwidth that satisfies the threshold.

In some aspects, a resource pool may contain only one of SBFD slots or uplink slots. For example, in some aspects, a resource pool cannot contain both an SBFD slot and an uplink slot. In this case, the network entity may configure separate resource pools for different slot types. For example, the network entity may configure a first resource pool that contains only SBFD slots and a second resource pool that contains only uplink slots. In some aspects, configuration information for a resource pool may indicate a slot type associated with the resource pool. For example, the information shown by reference number 710 may indicate whether the resource pool contains SBFD slots or uplink slots. In this way, sidelink operation on a carrier with SBFD slots is enabled, with only minor impact on existing sidelink operations (such as configuration or preconfiguration of a slot type for a given resource pool).

In some aspects, a resource pool can contain at least one of SBFD slots or uplink slots. For example, in some aspects, a resource pool can contain both uplink slots (e.g., slots with a threshold number of semi-static uplink symbols) and slots indicated semi-statically to be for SBFD operation. In this case, a frequency resource indication for the resource pool may use a same sub-channel indexing scheme for uplink slots and for SBFD slots. Configuring a resource pool that contains both uplink slots and SBFD slots may reduce latency on the sidelink relative to configuring resource pools that contain only one of uplink slots or SBFD slots.

In some aspects, the information shown by reference number 710 may indicate frequency resources for a resource pool. For example, a resource pool may include a number of contiguous sub-channels. A sub-channel may be configured as a number of contiguous physical resource blocks (PRBs) (which may be referred to herein as resource blocks (RBs)). The number of contiguous sub-channels and the number of contiguous PRBs (e.g., the size of a sub-channel) may be configured by a higher layer, such as by the network entity using parameters sl-NumSub-channel and sl-Sub-channelSize. Generally, a bandwidth of an uplink slot may be larger than a bandwidth of an SBFD slot on the same carrier or BWP. In some aspects, the network entity may configure a first number of sub-channels for uplink slots and a second number of sub-channels for SBFD slots. For example, the network entity may provide a first parameter indicating a number of sub-channels specific to uplink slots of a given resource pool, and a second parameter indicating a number of sub-channels specific to SBFD slots of the given resource pool. As another example, the network entity may configure a first resource pool to include only uplink slots with a number of sub-channels specific to uplink slots, and/or a second resource pool to include only SBFD slots with a number of sub-channels specific to SBFD slots.

In some aspects, the sub-channel size of a given resource pool (e.g., the number of contiguous PRBs associated with the given resource pool) may be independent of slot type. For example, a same sub-channel size may be used for SBFD slots and for uplink slots of the given resource pool, which reduces impact on resource reservation (for Mode 2 resource allocation) and resource allocation (for Mode 1 resource allocation). In some aspects, the sub-channel size of a given resource pool may be based at least in part on a slot type. For example, the sub-channel size of a given resource pool may be dependent on the slot type. In some aspects, the sub-channel size of a given resource pool may be different for uplink slots of the resource pool than for SBFD slots of the resource pool. For example, the given resource pool may use a first number of PRBs for uplink slots and a second (smaller) number of PRBs for SBFD slots. In some aspects, the sub-channel size for a resource pool including only uplink slots may be different than the sub-channel size for a resource pool including only SBFD slots. For example, a resource pool including only uplink slots may be configured with a first number of contiguous PRBs, and a resource pool including only SBFD slots may be configured with a second (smaller) number of PRBs.

In some aspects, the UE may determine a set of frequency resources to be included in a resource pool. For example, the information shown by reference number 710 may indicate a set of RBs (e.g., PRBs) for a resource pool that includes both uplink slots and SBFD slots (or only SBFD slots). This set of RBs may be used for uplink slots of the resource pool. The UE may identify a truncated set of RBs for the resource pool to be used in SBFD slots. For example, the UE may automatically truncate the resource pool in SBFD slots to the uplink portion of the frequency of the SBFD slots. In some aspects, the UE may truncate the resource pool in SBFD slots to include the uplink portion of the frequency and a gap. In this case, the UE may use the semi-static uplink portion of the bandwidth in the SBFD slots. For example, the UE may exclude dynamically switched RBs from the resource pool.

In some aspects, the network entity may configure separate sets of frequency resources (RBs) for uplink slots and for SBFD slots. For example, the network entity may provide a first parameter indicating a number of RBs for uplink slots of a resource pool and one or more second parameters indicating a number of RBs for one or more SBFD slots of the resource pool. Thus, processing resource usage of the UE may be reduced relative to UE-side determination of the frequency resources to be used for uplink slots and for SBFD slots.

As shown by reference number 720, the UE may communicate on one or more resource pools based at least in part on identifying the set of resources included in the one or more resource pools. For example, the UE may transmit a communication to another UE using a sidelink interface on a resource included in the one or more resource pools. In some aspects, the UE may transmit a resource reservation, a data communication, information indicating resources of the one or more resource pools, or the like. In some aspects, the UE and/or the network entity may perform full-duplex communication in an SBFD slot. For example, the UE may transmit a sidelink communication on an uplink portion of the SBFD slot that is included in the resource pool, and may receive a downlink communication or a sidelink communication on another portion of the SBFD slot that is not included in the resource pool. As another example, the network entity may communicate with the UE via a downlink portion of the SBFD slot while the UE communicates with another UE via the uplink portion of the SBFD slot that is included in the resource pool. Thus, techniques described herein reduce ambiguity with configuration and usage of resource pools on carriers associated with a mix of SBFD slots and uplink slots, which enables efficient sidelink communication on such carriers, thereby improving throughput and efficiency of sidelink communications.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with sidelink resource pool configuration.

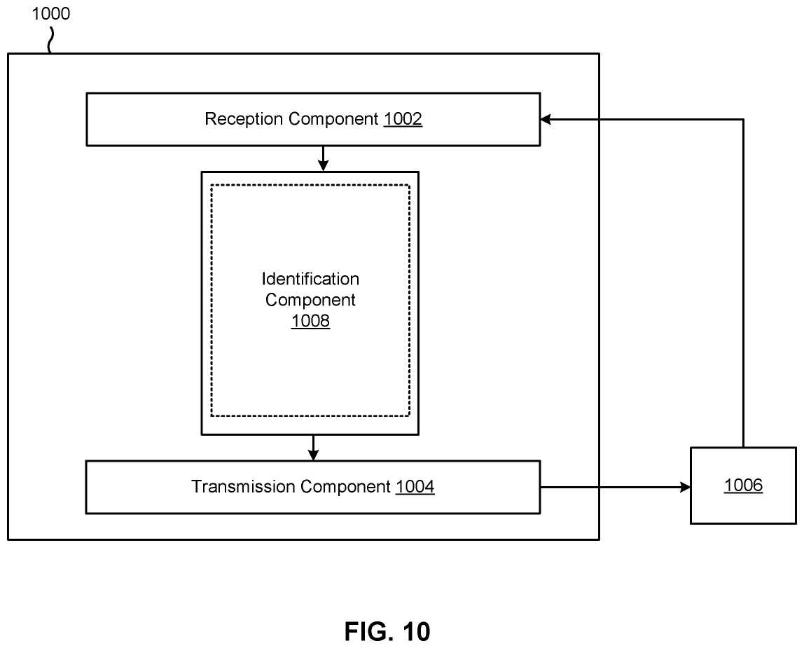

As shown in FIG. 8, in some aspects, process 800 may include receiving information indicating a plurality of resources for a resource pool associated with sidelink communication (block 810). For example, the UE (e.g., using reception component 1002, depicted in FIG. 10) may receive information indicating a plurality of resources for a resource pool associated with sidelink communication, as described above. In some aspects, the plurality of resources may include time resources (e.g., slots, symbols) and/or frequency resources (e.g., RBs/PRBs, sub-channels).

As further shown in FIG. 8, in some aspects, process 800 may include identifying a set of resources of the plurality of resources to be included in the resource pool, wherein identifying the set of resources is based at least in part on one or more resources of the plurality of resources being smaller-bandwidth resources that are associated with a smaller bandwidth than a remainder of the plurality of resources (block 820). For example, the UE (e.g., using identification component 1008, depicted in FIG. 10) may identify a set of resources of the plurality of resources to be included in the resource pool, wherein identifying the set of resources is based at least in part on one or more resources of the plurality of resources being smaller-bandwidth resources that are associated with a smaller bandwidth than a remainder of the plurality of resources, as described above. For example, the set of resources may include semi-statically configured uplink resources in at least one of an uplink slot or an uplink portion of an SBFD slot. The set of resources may include a set of slots and/or a set of frequency resources. The one or more resources that are smaller-bandwidth resources may be SBFD slots.

As further shown in FIG. 8, in some aspects, process 800 may include communicating on the resource pool using at least part of the set of resources (block 830). For example, the UE (e.g., using transmission component 1004, depicted in FIG. 10) may communicate on the resource pool using at least part of the set of resources, as described above.

Process 800 may include additional aspects, such as any single aspect or any combination of aspects described below and/or in connection with one or more other processes described elsewhere herein.

In a first aspect, the one or more resources that are smaller-bandwidth resources are included in the set of resources.

In a second aspect, alone or in combination with the first aspect, the one or more resources that are smaller-bandwidth resources are selectively included in the set of resources based at least in part on whether a bandwidth of an uplink portion of the one or more resources satisfies a threshold.

In a third aspect, alone or in combination with one or more of the first and second aspects, the resource pool contains only one of smaller-bandwidth resources or uplink resources.

In a fourth aspect, alone or in combination with one or more of the first through third aspects, the resource pool is a first resource pool that contains only smaller-bandwidth resources, and process 800 further comprises receiving information indicating another plurality of resources for a second resource pool associated with sidelink communication, wherein the other plurality of resources includes only uplink resources.

In a fifth aspect, alone or in combination with one or more of the first through fourth aspects, the resource pool can contain at least one of smaller-bandwidth resources or uplink resources.

In a sixth aspect, alone or in combination with one or more of the first through fifth aspects, a number of sub-channels for the resource pool is configured separately for the smaller-bandwidth resources and for the uplink resources.

In a seventh aspect, alone or in combination with one or more of the first through sixth aspects, a sub-channel size for the resource pool is independent of a slot type of the set of resources.

In an eighth aspect, alone or in combination with one or more of the first through seventh aspects, a sub-channel size for the resource pool is dependent on a slot type of the set of resources, wherein the slot type indicates whether the set of resources are smaller-bandwidth resources or uplink resources.

In a ninth aspect, alone or in combination with one or more of the first through eighth aspects, the information indicating the plurality of resources indicates a set of resource blocks for uplink resources, and identifying the set of resources further comprises identifying a truncated set of resource blocks, from the set of resource blocks, for a smaller-bandwidth resource.

In a tenth aspect, alone or in combination with one or more of the first through ninth aspects, the truncated set of resource blocks includes an uplink portion of the smaller-bandwidth resource and a gap.

In an eleventh aspect, alone or in combination with one or more of the first through tenth aspects, the information indicating the plurality of resources indicates a first set of resource blocks for uplink resources and a second set of resource blocks for smaller-bandwidth resources.

In a twelfth aspect, alone or in combination with one or more of the first through eleventh aspects, the one or more resources that are smaller-bandwidth resources cannot be included in the set of resources.

In a thirteenth aspect, alone or in combination with one or more of the first through twelfth aspects, the plurality of resources is a plurality of slots.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., BS 110, a gNB, the network entity of FIG. 7, one or more network nodes) performs operations associated with sidelink resource pool configuration.

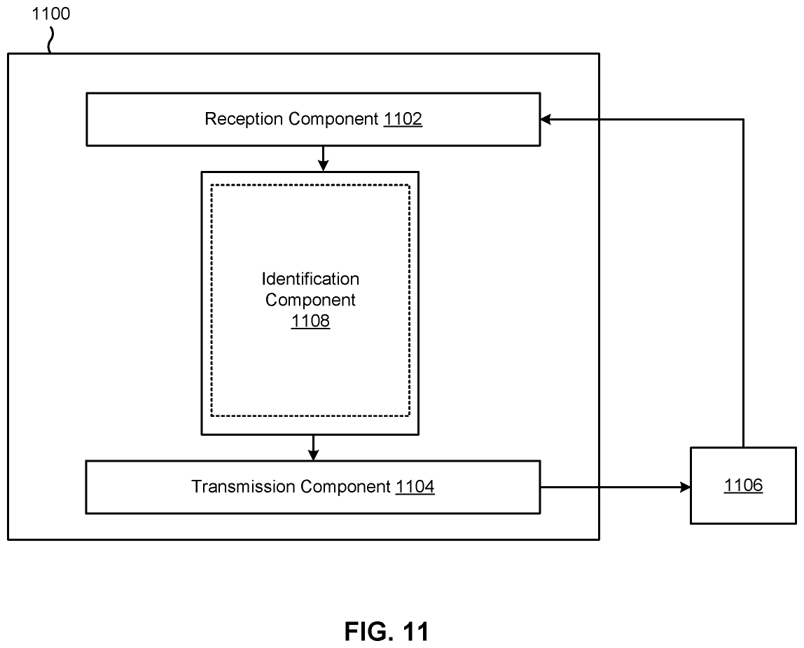

As shown in FIG. 9, in some aspects, process 900 may include identifying a plurality of resources for a resource pool associated with sidelink communication, wherein a set of resources of the plurality of resources are included in the resource pool, wherein the set of resources is based at least in part on one or more resources of the plurality of resources being smaller-bandwidth resources that are associated with a smaller bandwidth than a remainder of the plurality of resources (block 910). For example, the network entity (e.g., using identification component 1108, depicted in FIG. 11) may identify a plurality of resources for a resource pool associated with sidelink communication, wherein a set of resources of the plurality of resources are included in the resource pool, wherein the set of resources is based at least in part on one or more resources of the plurality of resources being smaller-bandwidth resources that are associated with a smaller bandwidth than a remainder of the plurality of resources, as described above. For example, the set of resources may include semi-statically configured uplink resources in at least one of an uplink slot or an uplink portion of an SBFD slot. The set of resources may include, for example, a set of slots and/or a set of frequency resources. The one or more resources that are smaller-bandwidth resources may be SBFD slots.

As further shown in FIG. 9, in some aspects, process 900 may include transmitting information indicating the plurality of resources for the resource pool or the set of resources for the resource pool (block 920). For example, the network entity (e.g., using transmission component 1104, depicted in FIG. 11) may transmit information indicating the plurality of resources for the resource pool or the set of resources for the resource pool, as described above.

Process 900 may include additional aspects, such as any single aspect or any combination of aspects described below and/or in connection with one or more other processes described elsewhere herein.

In a first aspect, the one or more resources that are smaller-bandwidth resources are included in the set of resources.

In a second aspect, alone or in combination with the first aspect, the one or more resources that are smaller-bandwidth resources are selectively included in the set of resources based at least in part on whether a bandwidth of an uplink portion of the one or more resources satisfies a threshold.

In a third aspect, alone or in combination with one or more of the first and second aspects, the resource pool contains only one of smaller-bandwidth resources, or uplink resources.

In a fourth aspect, alone or in combination with one or more of the first through third aspects, the resource pool is a first resource pool that contains only smaller-bandwidth resources, and process 900 further comprises transmitting information indicating another plurality of resources for a second resource pool associated with sidelink communication, wherein the other plurality of resources includes only uplink resources.

In a fifth aspect, alone or in combination with one or more of the first through fourth aspects, the resource pool can contain at least one of smaller-bandwidth resources, or uplink resources.

In a sixth aspect, alone or in combination with one or more of the first through fifth aspects, a number of sub-channels for the resource pool is configured separately for the smaller-bandwidth resources and for the uplink resources.

In a seventh aspect, alone or in combination with one or more of the first through sixth aspects, a sub-channel size for the resource pool is independent of a slot type of the set of resources.

In an eighth aspect, alone or in combination with one or more of the first through seventh aspects, a sub-channel size for the resource pool is dependent on a slot type of the set of resources, wherein the slot type indicates whether the set of resources are smaller-bandwidth resources or uplink resources.

In a ninth aspect, alone or in combination with one or more of the first through eighth aspects, the information indicating the plurality of resources indicates a set of resource blocks for uplink resources, and identifying the set of resources further comprises identifying a truncated set of resource blocks, from the set of resource blocks, for a smaller-bandwidth resource.

In a tenth aspect, alone or in combination with one or more of the first through ninth aspects, the truncated set of resource blocks includes an uplink portion of the smaller-bandwidth resource and a gap.

In an eleventh aspect, alone or in combination with one or more of the first through tenth aspects, the information indicating the plurality of resources indicates a first set of resource blocks for uplink resources and a second set of resource blocks for smaller-bandwidth resources.

In a twelfth aspect, alone or in combination with one or more of the first through eleventh aspects, the one or more resources that are smaller-bandwidth resources cannot be included in the set of resources.

In a thirteenth aspect, alone or in combination with one or more of the first through twelfth aspects, the plurality of resources is a plurality of slots.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include an identification component 1008, among other examples.

In some aspects, the apparatus 1000 may be configured to perform one or more operations described herein in connection with FIGS. 3-8. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a demodulator, a MIMO detector, a receive processor, a controller/processor, a memory, or a combination thereof, of the UE described above in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described above in connection with FIG. 2. In some aspects, the transmission component 1004 may be co-located with the reception component 1002 in a transceiver.

The reception component 1002 may receive information indicating a plurality of resources for a resource pool associated with sidelink communication. The identification component 1008 may identify a set of resources of the plurality of resources to be included in the resource pool, wherein identifying the set of resources is based at least in part on one or more resources of the plurality of resources being smaller-bandwidth resources that are associated with a smaller bandwidth than a remainder of the plurality of resources. The transmission component 1004 may communicate on the resource pool using at least part of the set of resources.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a block diagram of an example apparatus 1100 for wireless communication. The apparatus 1100 may be a network entity, or a network entity may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include an identification component 1108, among other examples.

In some aspects, the apparatus 1100 may be configured to perform one or more operations described herein in connection with FIGS. 3-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network entity described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a demodulator, a MIMO detector, a receive processor, a controller/processor, a memory, or a combination thereof, of the network entity described above in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the network entity described above in connection with FIG. 2. In some aspects, the transmission component 1104 may be co-located with the reception component 1102 in a transceiver.

The identification component 1108 may identify a plurality of resources for a resource pool associated with sidelink communication, wherein a set of resources of the plurality of resources are included in the resource pool, wherein the set of resources is based at least in part on one or more resources of the plurality of resources being smaller-bandwidth resources that are associated with a smaller bandwidth than a remainder of the plurality of resources. The transmission component 1104 may transmit information indicating the plurality of resources for the resource pool or the set of resources for the resource pool.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving information indicating a plurality of resources for a resource pool associated with sidelink communication; identifying a set of resources of the plurality of resources to be included in the resource pool, wherein identifying the set of resources is based at least in part on one or more resources of the plurality of resources being smaller-bandwidth resources that are associated with a smaller bandwidth than a remainder of the plurality of resources; and communicating on the resource pool using at least part of the set of resources.

Aspect 2: The method of Aspect 1, wherein the one or more resources that are smaller-bandwidth resources are included in the set of resources.

Aspect 3: The method of any of Aspects 1-2, wherein the one or more resources that are smaller-bandwidth resources are selectively included in the set of resources based at least in part on whether a bandwidth of an uplink portion of the one or more resources satisfies a threshold.

Aspect 4: The method of any of Aspects 1-3, wherein the resource pool contains only one of: smaller-bandwidth resources, or uplink resources.

Aspect 5: The method of Aspect 4, wherein the resource pool is a first resource pool that contains only smaller-bandwidth resources, and wherein the method further comprises: receiving information indicating another plurality of resources for a second resource pool associated with sidelink communication, wherein the other plurality of resources includes only uplink resources.

Aspect 6: The method of any of Aspects 1-5, wherein the resource pool can contain at least one of: smaller-bandwidth resources, or uplink resources.

Aspect 7: The method of Aspect 6, wherein a number of sub-channels for the resource pool is configured separately for the smaller-bandwidth resources and for the uplink resources.

Aspect 8: The method of Aspect 6, wherein a sub-channel size for the resource pool is independent of a slot type of the set of resources.

Aspect 9: The method of Aspect 6, wherein a sub-channel size for the resource pool is dependent on a slot type of the set of resources, wherein the slot type indicates whether the set of resources are smaller-bandwidth resources or uplink resources.

Aspect 10: The method of Aspect 6, wherein the information indicating the plurality of resources indicates a set of resource blocks for uplink resources, and wherein identifying the set of resources further comprises: identifying a truncated set of resource blocks, from the set of resource blocks, for a smaller-bandwidth resource.

Aspect 11: The method of Aspect 10, wherein the truncated set of resource blocks includes an uplink portion of the smaller-bandwidth resource and a gap.

Aspect 12: The method of Aspect 6, wherein the information indicating the plurality of resources indicates a first set of resource blocks for uplink resources and a second set of resource blocks for smaller-bandwidth resources.

Aspect 13: The method of any of Aspects 1-12, wherein the one or more resources that are smaller-bandwidth resources cannot be included in the set of resources.

Aspect 14: The method of any of Aspects 1-13, wherein the plurality of resources is a plurality of slots.

Aspect 15: The method of any of Aspects 1-14, wherein the smaller-bandwidth resources are SBFD resources.

Aspect 16: A method of wireless communication performed by a network entity, comprising: identifying a plurality of resources for a resource pool associated with sidelink communication, wherein a set of resources of the plurality of resources are included in the resource pool, wherein the set of resources is based at least in part on one or more resources of the plurality of resources being smaller-bandwidth resources that are associated with a smaller bandwidth than a remainder of the plurality of resources; and transmitting information indicating the plurality of resources for the resource pool or the set of resources for the resource pool.

Aspect 17: The method of Aspect 16, wherein the one or more resources that are smaller-bandwidth resources are included in the set of resources.

Aspect 18: The method of any of Aspects 16-17, wherein the one or more resources that are smaller-bandwidth resources are selectively included in the set of resources based at least in part on whether a bandwidth of an uplink portion of the one or more resources satisfies a threshold.

Aspect 19: The method of any of Aspects 16-18, wherein the resource pool contains only one of: smaller-bandwidth resources, or uplink resources.

Aspect 20: The method of Aspect 19, wherein the resource pool is a first resource pool that contains only smaller-bandwidth resources, and wherein the method further comprises: transmitting information indicating another plurality of resources for a second resource pool associated with sidelink communication, wherein the other plurality of resources includes only uplink resources.

Aspect 21: The method of any of Aspects 16-18, wherein the resource pool can contain at least one of: smaller-bandwidth resources, or uplink resources.

Aspect 22: The method of Aspect 21, wherein a number of sub-channels for the resource pool is configured separately for the smaller-bandwidth resources and for the uplink resources.

Aspect 23: The method of Aspect 21, wherein a sub-channel size for the resource pool is independent of a slot type of the set of resources.

Aspect 24: The method of Aspect 21, wherein a sub-channel size for the resource pool is dependent on a slot type of the set of resources, wherein the slot type indicates whether the set of resources are smaller-bandwidth resources or uplink resources.

Aspect 25: The method of Aspect 21, wherein the information indicating the plurality of resources indicates a set of resource blocks for uplink resources, and wherein identifying the set of resources further comprises: identifying a truncated set of resource blocks, from the set of resource blocks, for a smaller-bandwidth resource.

Aspect 26: The method of Aspect 25, wherein the truncated set of resource blocks includes an uplink portion of the smaller-bandwidth resource and a gap.

Aspect 27: The method of Aspect 25, wherein the information indicating the plurality of resources indicates a first set of resource blocks for uplink resources and a second set of resource blocks for smaller-bandwidth resources.

Aspect 28: The method of any of Aspects 16-18, wherein the one or more resources that are smaller-bandwidth resources cannot be included in the set of resources.

Aspect 29: The method of any of Aspects 16-28, wherein the plurality of resources is a plurality of slots.

Aspect 30: An apparatus for wireless communication at a device, comprising a processor; memory coupled with the processor; and instructions stored in the memory and executable by the processor to cause the apparatus to perform the method of one or more Aspects of Aspects 1-29.

Aspect 31: A device for wireless communication, comprising a memory and one or more processors coupled to the memory, the one or more processors configured to perform the method of one or more Aspects of Aspects 1-29.

Aspect 32: An apparatus for wireless communication, comprising at least one means for performing the method of one or more Aspects of Aspects 1-29.

Aspect 33: A non-transitory computer-readable medium storing code for wireless communication, the code comprising instructions executable by a processor to perform the method of one or more Aspects of Aspects 1-29.

Aspect 34: A non-transitory computer-readable medium storing a set of instructions for wireless communication, the set of instructions comprising one or more instructions that, when executed by one or more processors of a device, cause the device to perform the method of one or more Aspects of Aspects 1-29.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive information indicating a plurality of resources for a resource pool associated with sidelink communication;
identify a set of resources of the plurality of resources to be included in the resource pool, wherein identifying the set of resources is based at least in part on one or more resources of the plurality of resources being smaller-bandwidth resources that are associated with a smaller bandwidth than a remainder of the plurality of resources; and
communicate on the resource pool using at least part of the set of resources.

2. The UE of claim 1, wherein the one or more resources that are smaller-bandwidth resources are included in the set of resources.

3. The UE of claim 1, wherein the one or more resources that are smaller-bandwidth resources are selectively included in the set of resources based at least in part on whether a bandwidth of an uplink portion of the one or more resources satisfies a threshold.

4. The UE of claim 1, wherein the resource pool contains only one of:
smaller-bandwidth resources, or
uplink resources.

5. The UE of claim 1, wherein the resource pool is a first resource pool that contains only smaller-bandwidth resources, and wherein the one or more processors are configured to:
receive information indicating another plurality of resources for a second resource pool associated with sidelink communication, wherein the other plurality of resources includes only uplink resources.

6. The UE of claim 1, wherein the resource pool can contain at least one of:
smaller-bandwidth resources, or
uplink resources.

7. The UE of claim 6, wherein a number of sub-channels for the resource pool is configured separately for the smaller-bandwidth resources and for the uplink resources.

8. The UE of claim 1, wherein a sub-channel size for the resource pool is independent of a slot type of the set of resources.

9. The UE of claim 1, wherein a sub-channel size for the resource pool is dependent on a slot type of the set of resources, wherein the slot type indicates whether the set of resources are smaller-bandwidth resources or uplink resources.

10. The UE of claim 1, wherein the information indicating the plurality of resources indicates a set of resource blocks for uplink resources, and wherein the one or more processors, to identify the set of resources, are configured to:
identify a truncated set of resource blocks, from the set of resource blocks, for a smaller-bandwidth resource.

11. The UE of claim 10, wherein the truncated set of resource blocks includes an uplink portion of the smaller-bandwidth resource and a gap.

12. The UE of claim 1, wherein the information indicating the plurality of resources indicates a first set of resource blocks for uplink resources and a second set of resource blocks for smaller-bandwidth resources.

13. The UE of claim 1, wherein the one or more resources that are smaller-bandwidth resources cannot be included in the set of resources.

14. The UE of claim 1, wherein the plurality of resources is a plurality of slots.

15. The UE of claim 1, wherein the one or more resources that are smaller-bandwidth resources are slot-based full duplex (SBFD) resources.

16. A network entity for wireless communication, comprising:
a memory; and
one or more processors, coupled to the memory, configured to:
identify a plurality of resources for a resource pool associated with sidelink communication, wherein a set of resources of the plurality of resources are included in the resource pool, wherein the set of resources is based at least in part on one or more resources of the plurality of resources being smaller-bandwidth resources that are associated with a smaller bandwidth than a remainder of the plurality of resources; and
transmit information indicating the plurality of resources for the resource pool or the set of resources for the resource pool.

17. The network entity of claim 16, wherein the resource pool contains only one of:
smaller-bandwidth resources, or
uplink resources.

18. The network entity of claim 17, wherein the resource pool is a first resource pool that contains only smaller-bandwidth resources, and wherein the one or more processors are configured to:
transmit information indicating another plurality of resources for a second resource pool associated with sidelink communication, wherein the other plurality of resources includes only uplink resources.

19. The network entity of claim 16, wherein the resource pool can contain at least one of:
smaller-bandwidth resources, or
uplink resources.

20. The network entity of claim 19, wherein a sub-channel size for the resource pool is dependent on a slot type of the set of resources, wherein the slot type indicates whether the set of resources are smaller-bandwidth resources or uplink resources.

21. The network entity of claim 19, wherein the information indicating the plurality of resources indicates a set of resource blocks for uplink resources, and wherein the one or more processors, to identify the set of resources, are configured to:
identify a truncated set of resource blocks, from the set of resource blocks, for a smaller-bandwidth resource.

22. The network entity of claim 21, wherein the truncated set of resource blocks includes an uplink portion of the smaller-bandwidth resource and a gap.

23. The network entity of claim 22, wherein the information indicating the plurality of resources indicates a first set of resource blocks for uplink resources and a second set of resource blocks for smaller-bandwidth resources.

24. A method of wireless communication performed by a user equipment (UE), comprising:
receiving information indicating a plurality of resources for a resource pool associated with sidelink communication;
identifying a set of resources of the plurality of resources to be included in the resource pool, wherein identifying the set of resources is based at least in part on one or more resources of the plurality of resources being smaller-bandwidth resources that are associated with a smaller bandwidth than a remainder of the plurality of resources; and
communicating on the resource pool using at least part of the set of resources.

25. The method of claim 24, wherein the one or more resources that are smaller-bandwidth resources are included in the set of resources.

26. The method of claim 24, wherein the one or more resources that are smaller-bandwidth resources are selectively included in the set of resources based at least in part on whether a bandwidth of an uplink portion of the one or more resources satisfies a threshold.

27. A method of wireless communication performed by a network entity, comprising:
identifying a plurality of resources for a resource pool associated with sidelink communication, wherein a set of resources of the plurality of resources are included in the resource pool, wherein the set of resources is based at least in part on one or more resources of the plurality of resources being smaller-bandwidth resources that are associated with a smaller bandwidth than a remainder of the plurality of resources; and
transmitting information indicating the plurality of resources for the resource pool or the set of resources for the resource pool.

28. The method of claim 27, wherein the resource pool contains only one of:
smaller-bandwidth resources, or
uplink resources.

29. The method of claim 28, wherein the resource pool is a first resource pool that contains only smaller-bandwidth resources, and wherein the method further comprises:
transmitting information indicating another plurality of resources for a second resource pool associated with sidelink communication, wherein the other plurality of resources includes only uplink resources.

30. The method of claim 27, wherein the resource pool can contain at least one of:
smaller-bandwidth resources, or
uplink resources.
